(19) United States
(12) Patent Application Publication
(10) Pub. No.: US 2025/0121700 A1
(43) Pub. Date: Apr. 17, 2025

(54) CONTROL METHOD OF DRIVE SYSTEM FOR MOBILE VEHICLE, CONTROL SYSTEM OF MOBILE VEHICLE, AND DOMAIN CONTROL UNIT OF MOBILE VEHICLE

(71) Applicant: FOXTRON VEHICLE TECHNOLOGIES CO., LTD., New Taipei City (TW)

(72) Inventors: TSENG-TI FU, New Taipei City (TW); QI-XUAN BU, New Taipei City (TW); RONG-SYUAN CHANG, New Taipei City (TW)

(21) Appl. No.: 18/591,318

(22) Filed: Feb. 29, 2024

(30) Foreign Application Priority Data
Oct. 16, 2023 (TW) 112139383

(51) Int. Cl. B60L 15/20

(52) U.S. Cl. CPC B60L 15/2036; B60L 2240/12; B60L 2240/22; B60L 2240/24; B60L 2240/423; B60L 2240/465

(57) ABSTRACT

A control method of a drive system for a mobile vehicle, and a control system and a domain control unit of a mobile vehicle are provided. The control method is applied to the mobile vehicle, and includes: (A) calculating a target yaw rate of the mobile vehicle; (B) calculating a difference between an actual yaw rate of the mobile vehicle and the target yaw rate to obtain a yaw error; and (C) controlling, in response to the yaw error being greater than a third reference value, at least one of a torque output by a first drive unit and a torque output by a second drive unit, such that the yaw error is decreased or eliminated. Accordingly, the control method of the drive system and the control system of the mobile vehicle are capable of eliminating occurrence of an inner wheel difference during turning of the mobile vehicle.

### CROSS-REFERENCE TO RELATED PATENT APPLICATION

This application claims the benefit of priority to Taiwan Patent Application No. 112139383, filed on Oct. 16, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a control method, a control system, and a domain control unit, and more particularly to a control method and a control system of a mobile vehicle in which a drive system of the mobile vehicle is capable of preventing occurrence of an inner wheel difference during turning of the mobile vehicle.

### BACKGROUND OF THE DISCLOSURE

When in motion, a four-wheel steering vehicle that is equipped with a steering system at both the front and the rear of the vehicle can have improved vehicle maneuverability (e.g., have a reduced turning radius, have enhanced steering flexibility and stability, and eliminate an inner wheel difference during turning). Since the steering system needs to be installed at a rear axle, much space of a rear wheelhouse will be occupied thereby, which can compromise rear seat comfort and reduce a cargo space. Hence, a rear-axle steering system currently available on the market mainly adopts a small steering angle for occupying less space for rear seating and cargo, but such an approach is not sufficient for effectively resolving the issue.

Therefore, how to overcome the above-mentioned problem through improvements in the system structure has become one of the important issues to be solved in the related art.

### SUMMARY OF THE DISCLOSURE

In response to the above-referenced technical inadequacy, the present disclosure provides a control method of a drive system for a mobile vehicle, a control system of a mobile vehicle, and a domain control unit of a mobile vehicle.

In order to solve the above-mentioned problem, one of the technical aspects adopted by the present disclosure is to provide a control method of a drive system, which is applied to a mobile vehicle. The control method includes: (A) calculating a target yaw rate of the mobile vehicle; (B) calculating a difference between an actual yaw rate of the mobile vehicle and the target yaw rate to obtain a yaw error; and (C) controlling, in response to the yaw error being greater than a third reference value, at least one of a torque output by a first drive unit and a torque output by a second drive unit, such that the yaw error is decreased or eliminated.

In one of the possible or preferred embodiments, the control method further includes: obtaining a steering angle value of the mobile vehicle, and performing the processes (A), (B), and (C) when the steering angle value is greater than a first reference value.

In one of the possible or preferred embodiments, the process (C) includes: calculating a first torque correction value based on the yaw error; calculating a second torque correction value based on the steering angle value and a vehicle speed of the mobile vehicle; adjusting, based on a sum of the first torque correction value and the second torque correction value that are each weighted by a weighting coefficient of the first drive unit, the torque output by the first drive unit; and/or adjusting, based on a sum of the first torque correction value and the second torque correction value that are each weighted by a weighting coefficient of the second drive unit, the torque output by the second drive unit.

In one of the possible or preferred embodiments, the process (C) further includes: obtaining a first wheel slip value and a second wheel slip value of the mobile vehicle; calculating, in response to the first wheel slip value being greater than a fourth reference value, a third torque correction value based on the first wheel slip value, and further using the third torque correction value as a basis for adjusting the torque output by the first drive unit; and/or calculating, in response to the second wheel slip value being greater than the fourth reference value, a fourth torque correction value based on the second wheel slip value, and further using the fourth torque correction value as a basis for adjusting the torque output by the second drive unit.

In one of the possible or preferred embodiments, the target yaw rate is a function of the steering angle value, a vehicle speed of the mobile vehicle, and at least one parameter specific to the mobile vehicle.

In one of the possible or preferred embodiments, when the yaw error is less than the third reference value, the control method further includes: obtaining a first wheel slip value and a second wheel slip value of the mobile vehicle; calculating, in response to the first wheel slip value being greater than a fourth reference value, a third torque correction value based on the first wheel slip value, and adjusting the torque output by the first drive unit based on the third torque correction value, such that the first wheel slip value is decreased or eliminated; and/or calculating, in response to the second wheel slip value being greater than the fourth reference value, a fourth torque correction value based on the second wheel slip value, and adjusting the torque output by the second drive unit based on the fourth torque correction value, such that the second wheel slip value is decreased or eliminated.

In one of the possible or preferred embodiments, the first drive unit and the second drive unit drive a left rear wheel and a right rear wheel of the mobile vehicle, respectively. The target yaw rate is configured to maximize an overlapping degree between trajectories of the left rear wheel and the right rear wheel and trajectories of a left front wheel and a right front wheel of the mobile vehicle, such that an inner wheel difference of the mobile vehicle during turning of the mobile vehicle is decreased or eliminated.

In one of the possible or preferred embodiments, the steering angle value is obtained from a steering angle of a wheel end of the mobile vehicle, an overall steering angle of the mobile vehicle, a steering angle of a steering wheel or a steering controller, a steering angle of a steering motor, or a stroke of a tie rod of a steering gear.

In order to solve the above-mentioned problem, another one of the technical aspects adopted by the present disclosure is to provide a control system of a mobile vehicle, which includes a first control unit and a second control unit. The first control unit is communicatively connected to the second control unit, and the control system performs a control method. The control method includes: (A) calculating, by the first control unit, a target yaw rate of the mobile vehicle; (B) calculating, by the first control unit, a difference between an actual yaw rate of the mobile vehicle and the target yaw rate to obtain a yaw error; and (C) controlling, by the second control unit, at least one of a torque output by a first drive unit of the mobile vehicle and a torque output by a second drive unit of the mobile vehicle in response to the first control unit determining that the yaw error is greater than a third reference value, such that the yaw error is decreased or eliminated.

In one of the possible or preferred embodiments, the first control unit is communicatively connected to a steering angle sensor of the mobile vehicle. When the first control unit obtains a steering angle value of the mobile vehicle by the steering angle sensor and determines that the steering angle value is greater than a first reference value, the control system performs the processes (A), (B), and (C).

In one of the possible or preferred embodiments, when the control system performs the process (C), further processes include: calculating, by the first control unit, a first torque correction value based on the yaw error; calculating, by the first control unit, a second torque correction value based on the steering angle value and a vehicle speed of the mobile vehicle; adjusting, by the second control unit, the torque output by the first drive unit based on a sum of the first torque correction value and the second torque correction value that are each weighted by a weighting coefficient of the first drive unit; and/or adjusting, by the second control unit, the torque output by the second drive unit based on a sum of the first torque correction value and the second torque correction value that are each weighted by a weighting coefficient of the second drive unit.

In one of the possible or preferred embodiments, when the control system performs the process (C), further processes include: obtaining, by the first control unit, a first wheel slip value and a second wheel slip value of the mobile vehicle; calculating, in response to the first control unit determining that the first wheel slip value is greater than a fourth reference value, a third torque correction value based on the first wheel slip value, and further using the third torque correction value as a basis for adjusting the torque output by the first drive unit; and/or calculating, in response to the first control unit determining that the second wheel slip value is greater than the fourth reference value, a fourth torque correction value based on the second wheel slip value, and further using the fourth torque correction value as a basis for adjusting the torque output by the second drive unit.

In one of the possible or preferred embodiments, the first control unit is a computation control unit or an electronic stability control unit, and the second control unit is a motor control unit. The steering angle value is obtained from a steering angle of a wheel end of the mobile vehicle, an overall steering angle of the mobile vehicle, a steering angle of a steering wheel or a steering controller, a steering angle of a steering motor, or a stroke of a tie rod of a steering gear. The target yaw rate is a function of the steering angle value, a vehicle speed of the mobile vehicle, and at least one parameter specific to the mobile vehicle.

In one of the possible or preferred embodiments, when the first control unit determines that the yaw error is less than the third reference value, the control system performs processes of: obtaining, by the first control unit, a first wheel slip value and a second wheel slip value of the mobile vehicle; calculating, in response to the first control unit determining that the first wheel slip value is greater than a fourth reference value, a third torque correction value based on the first wheel slip value, and using the second control unit to adjust the torque output by the first drive unit based on the third torque correction value, such that the first wheel slip value is decreased or eliminated; and/or calculating, in response to the first control unit determining that the second wheel slip value is greater than the fourth reference value, a fourth torque correction value based on the second wheel slip value, and using the second control unit to adjust the torque output by the second drive unit based on the fourth torque correction value, such that the second wheel slip value is decreased or eliminated.

In one of the possible or preferred embodiments, the first drive unit and the second drive unit drive a left rear wheel and a right rear wheel of the mobile vehicle, respectively. The target yaw rate is configured to maximize an overlapping degree between trajectories of the left rear wheel and the right rear wheel and trajectories of a left front wheel and a right front wheel of the mobile vehicle, such that an inner wheel difference of the mobile vehicle during turning of the mobile vehicle is decreased or eliminated.

In order to solve the above-mentioned problem, yet another one of the technical aspects adopted by the present disclosure is to provide a domain control unit of a mobile vehicle, and the domain control unit performs a control method. The control method includes: (A) calculating a target yaw rate of the mobile vehicle; (B) calculating a difference between an actual yaw rate of the mobile vehicle and the target yaw rate to obtain a yaw error; and (C) controlling, in response to determining that the yaw error is greater than a third reference value, at least one of a torque output by a first drive unit of the mobile vehicle and a torque output by a second drive unit of the mobile vehicle, such that the yaw error is decreased or eliminated.

In one of the possible or preferred embodiments, the domain control unit is connected to a steering angle sensor of the mobile vehicle. When the domain control unit obtains a steering angle value of the mobile vehicle by the steering angle sensor and determines that the steering angle value is greater than a first reference value, the domain control unit performs the processes (A), (B), and (C).

In one of the possible or preferred embodiments, the domain control unit performing the process (C) further includes performing processes of: calculating a first torque correction value based on the yaw error; calculating a second torque correction value based on the steering angle value and a vehicle speed of the mobile vehicle; adjusting, based on a sum of the first torque correction value and the second torque correction value that are each weighted by a weighting coefficient of the first drive unit, the torque output by the first drive unit; and/or adjusting, based on a sum of the first torque correction value and the second torque correction value that are each weighted by a weighting coefficient of the second drive unit, the torque output by the second drive unit.

In one of the possible or preferred embodiments, the domain control unit performing the process (C) further includes performing processes of: obtaining a first wheel slip value and a second wheel slip value of the mobile vehicle; calculating, in response to determining that the first wheel slip value is greater than a fourth reference value, a third torque correction value based on the first wheel slip value, and further using the third torque correction value as a basis for adjusting the torque output by the first drive unit; and/or calculating, in response to determining that the second wheel slip value is greater than the fourth reference value, a fourth torque correction value based on the second wheel slip value, and further using the fourth torque correction value as a basis for adjusting the torque output by the second drive unit.

In one of the possible or preferred embodiments, when the domain control unit determines that the yaw error is less than the third reference value, the domain control unit performs processes of: obtaining a first wheel slip value and a second wheel slip value of the mobile vehicle; calculating, in response to determining that the first wheel slip value is greater than a fourth reference value, a third torque correction value based on the first wheel slip value, and adjusting the torque output by the first drive unit based on the third torque correction value, such that the first wheel slip value is decreased or eliminated; and/or calculating, in response to determining that the second wheel slip value is greater than the fourth reference value, a fourth torque correction value based on the second wheel slip value, and adjusting the torque output by the second drive unit based on the fourth torque correction value, such that the second wheel slip value is decreased or eliminated.

Therefore, in the control method of the drive system provided by the present disclosure, by virtue of “(A) calculating a target yaw rate of the mobile vehicle,” “(B) calculating a difference between an actual yaw rate of the mobile vehicle and the target yaw rate to obtain a yaw error,” and “(C) controlling, in response to the yaw error being greater than a third reference value, at least one of a torque output by a first drive unit and a torque output by a second drive unit, such that the yaw error is decreased or eliminated,” the occurrence of the inner wheel difference during turning of the mobile vehicle can be eliminated.

Furthermore, in the control system of the mobile vehicle provided by the present disclosure, by virtue of “the control system including a first control unit and a second control unit,” “the first control unit being communicatively connected to the second control unit, and the control system performing a control method,” and “the control method including: (A) calculating, by the first control unit, a target yaw rate of the mobile vehicle; (B) calculating, by the first control unit, a difference between an actual yaw rate of the mobile vehicle and the target yaw rate to obtain a yaw error; and (C) controlling, by the second control unit, at least one of a torque output by a first drive unit of the mobile vehicle and a torque output by a second drive unit of the mobile vehicle in response to the first control unit determining that the yaw error is greater than a third reference value, such that the yaw error is decreased or eliminated,” the occurrence of the inner wheel difference during turning of the mobile vehicle can be eliminated.

Furthermore, in the domain control unit of the mobile vehicle provided by the present disclosure, by virtue of “the domain control unit performing a control method” and “the control method including: (A) calculating a target yaw rate of the mobile vehicle; (B) calculating a difference between an actual yaw rate of the mobile vehicle and the target yaw rate to obtain a yaw error; and (C) controlling, in response to determining that the yaw error is greater than a third reference value, at least one of a torque output by a first drive unit of the mobile vehicle and a torque output by a second drive unit of the mobile vehicle, such that the yaw error is decreased or eliminated,” the occurrence of the inner wheel difference during turning of the mobile vehicle can be eliminated.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1A shows a first part of a flowchart illustrating operations of a control method for a drive system, while FIG. 1B shows a second part of a flowchart illustrating operations of a control method for a drive system in accordance with some embodiments of the instant disclosure;

FIG. 2 is a curve diagram of Vehicle Calibration Table 1 according to one embodiment of the present disclosure;

FIG. 3 is a schematic diagram of Vehicle Calibration Table 2 according to one embodiment of the present disclosure;

FIG. 4 is a first functional block diagram of a control system of a mobile vehicle according to one embodiment of the present disclosure;

FIG. 5 is a second flowchart of the control method of the drive system according to one embodiment of the present disclosure;

FIG. 6 is a second functional block diagram of the control system of the mobile vehicle according to one embodiment of the present disclosure;

FIG. 7 is a third functional block diagram of the control system of the mobile vehicle according to one embodiment of the present disclosure; and

FIG. 8 is a fourth functional block diagram of the control system of the mobile vehicle according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### EMBODIMENTS

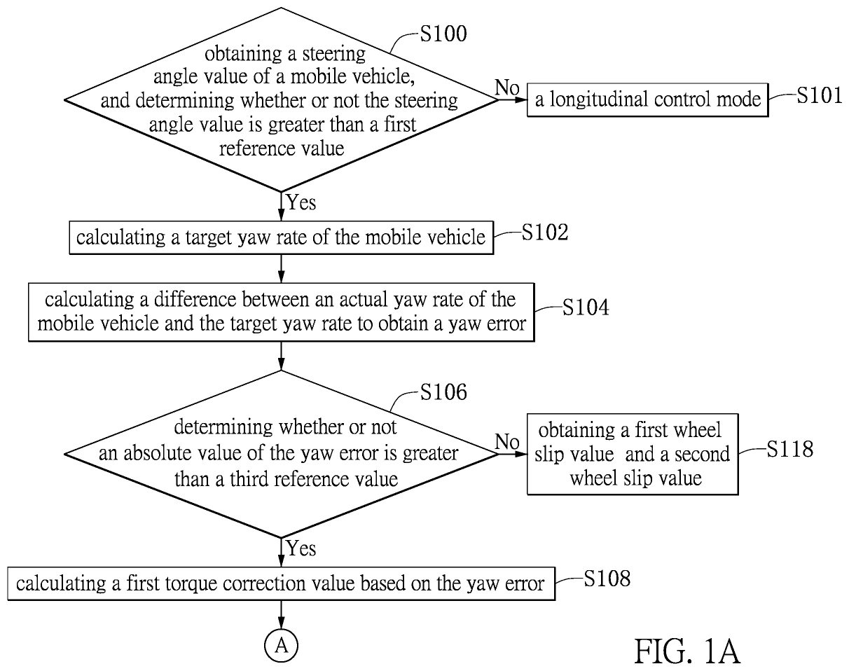

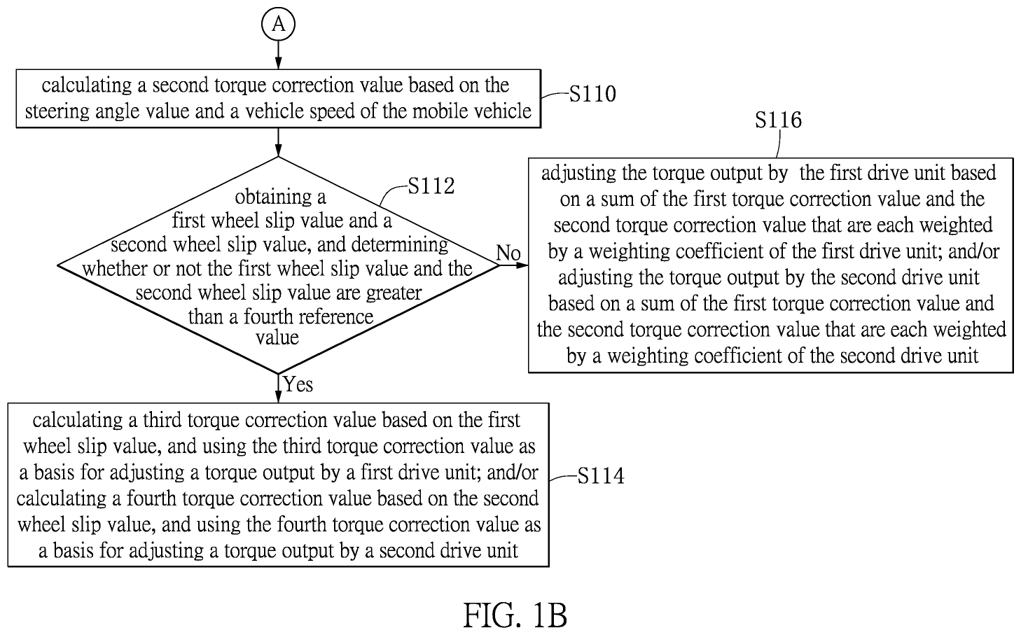

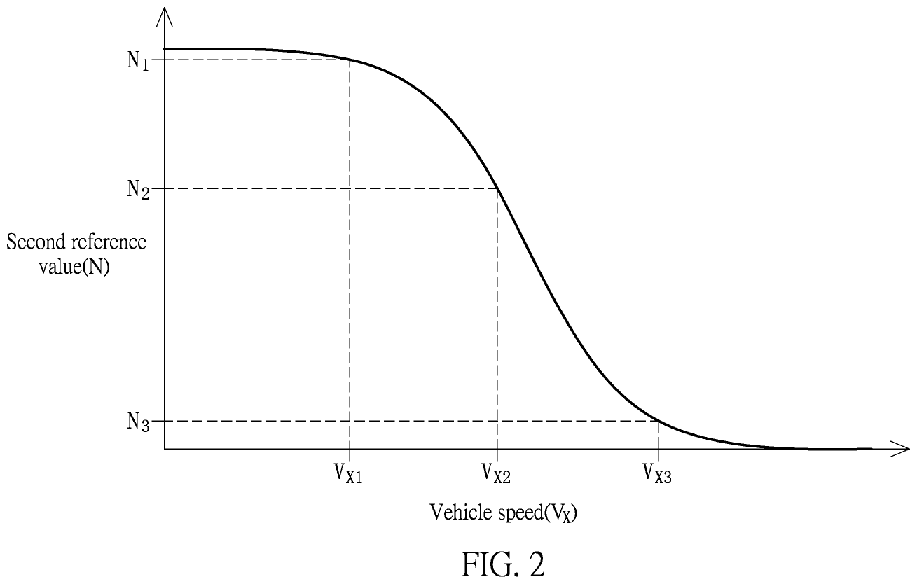

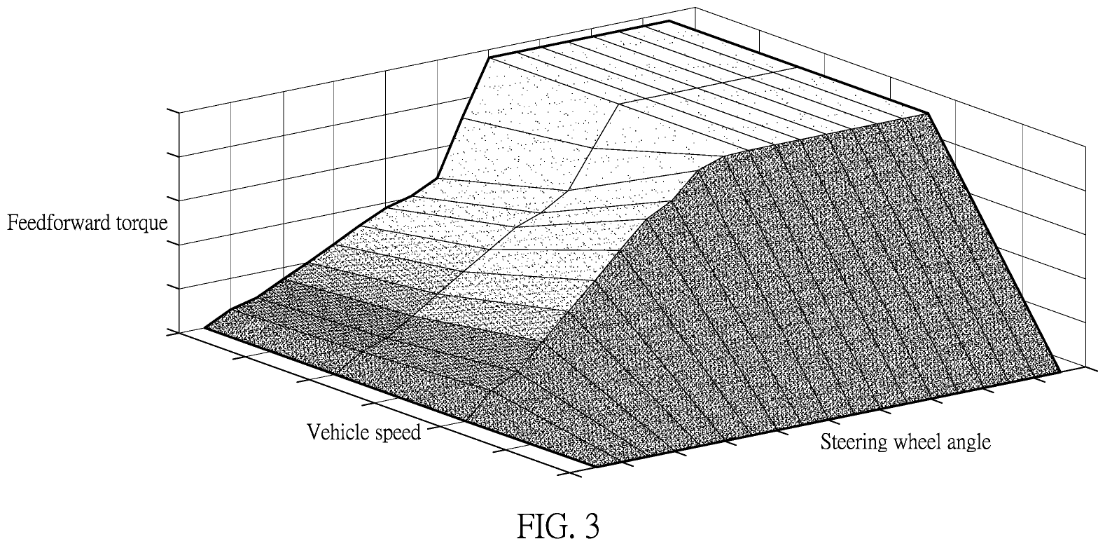

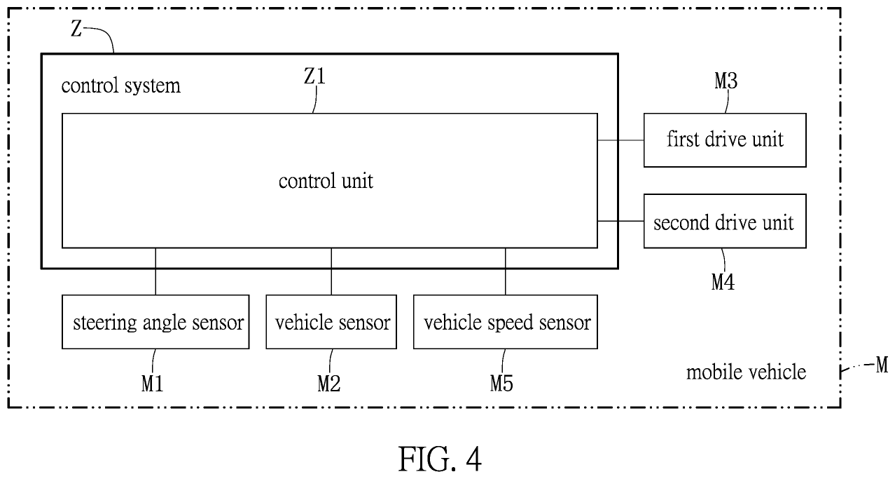

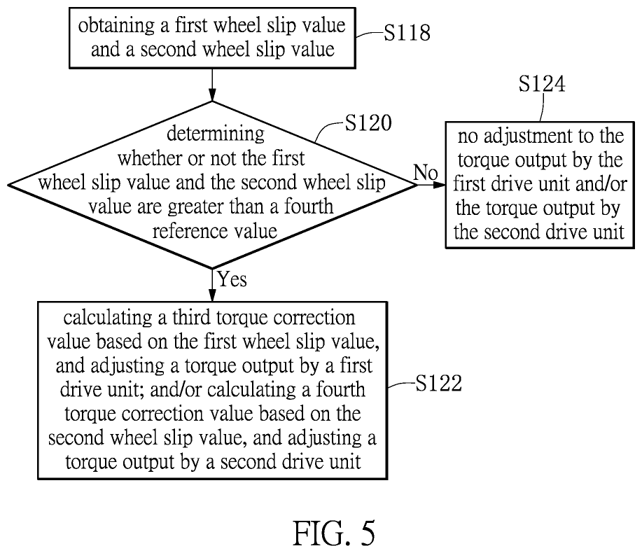

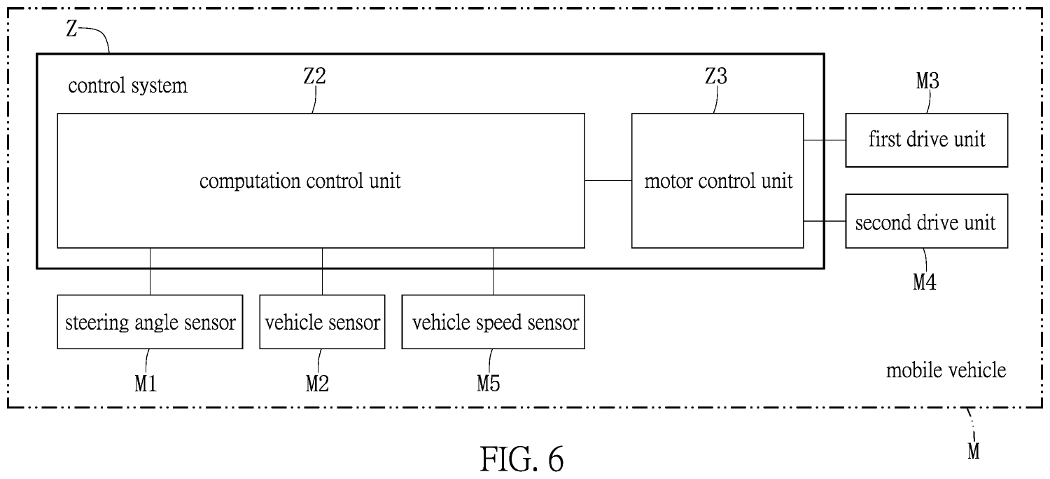

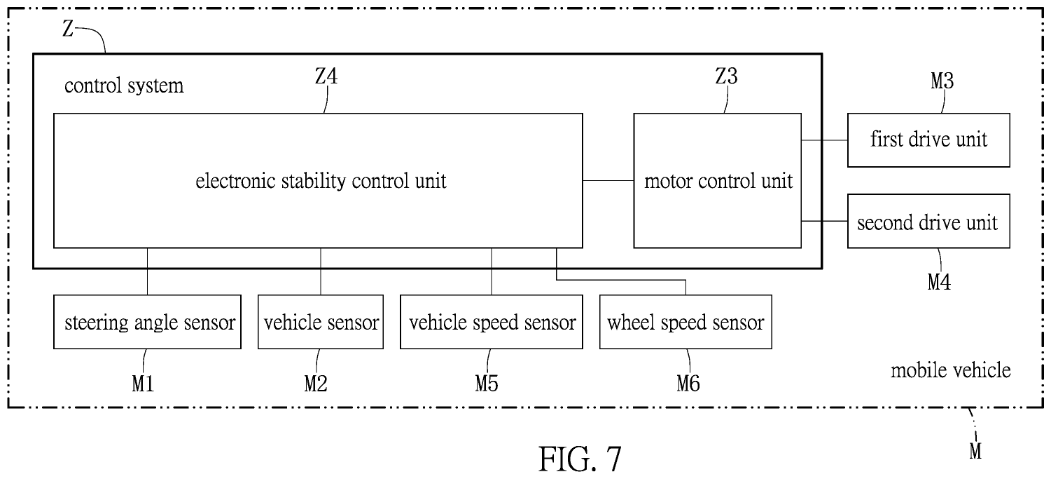

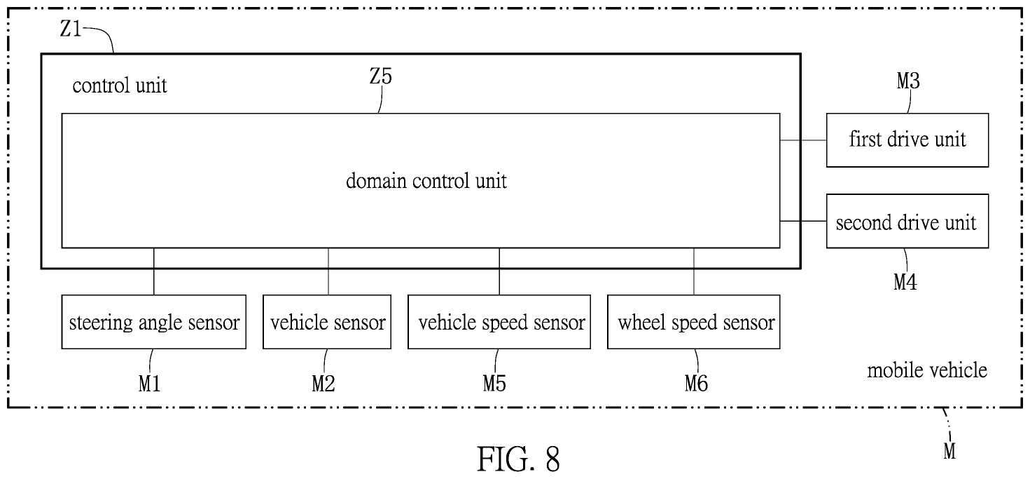

Referring to FIG. 1A, FIG. 1B to FIG. 8, FIG. 1A shows a first portion of a flowchart that illustrates operation processes of a control method for a drive system according to one embodiment of the present disclosure (whose process steps proceeds to node “A”), FIG. 1B shows a second portion of a flowchart that illustrates operation processes of a control method for a drive system in accordance with some embodiments of the present disclosure (which proceeds from node “A” as shown in FIG. 1A). FIG. 2 is a curve diagram of Vehicle Calibration Table 1 according to one embodiment of the present disclosure. FIG. 3 is a schematic diagram of Vehicle Calibration Table 2 according to one embodiment of the present disclosure. FIG. 4 is a first functional block diagram of a control system of a mobile vehicle according to one embodiment of the present disclosure. FIG. 5 is a second flowchart of the control method of the drive system according to one embodiment of the present disclosure. FIG. 6 is a second functional block diagram of the control system of the mobile vehicle according to one embodiment of the present disclosure. FIG. 7 is a third functional block diagram of the control system of the mobile vehicle according to one embodiment of the present disclosure. FIG. 8 is a fourth functional block diagram of the control system of the mobile vehicle according to one embodiment of the present disclosure. As shown in the above-mentioned drawings, a first embodiment of the present disclosure provides a control method of a drive system, which is applied to a mobile vehicle M. That is, the control method of the present disclosure is applicable to a drive system of the mobile vehicle M. The mobile vehicle M can be a vehicle that uses electricity as a power source and has four or more wheels (i.e., an electric vehicle), but is not limited thereto. The mobile vehicle M can also be a hybrid electric vehicle or a fuel vehicle.

In the present disclosure, the control method of the drive system at least includes the following processes: (A) calculating a target yaw rate of the mobile vehicle M; (B) calculating a difference between an actual yaw rate of the mobile vehicle M and the target yaw rate to obtain a yaw error; and (C) controlling, in response to the yaw error being greater than a third reference value, at least one of a torque output by a first drive unit and a torque output by a second drive unit, such that the yaw error is decreased or eliminated.

In the present disclosure, the control method of the drive system can further include: obtaining a steering angle value of the mobile vehicle M, and performing the processes (A), (B), and (C) when the steering angle value is greater than a first reference value.

Reference is made to FIG. 1A, FIG. 1B, FIG. 2, and FIG. 4. For example, when the control method of the drive system in the present disclosure is applied to the mobile vehicle M, the steering angle value of the mobile vehicle M is firstly obtained by a steering angle sensor M1 of the mobile vehicle M, and whether or not the steering angle value is greater than the first reference value is determined (step S100). Through the steering angle sensor M1, the steering angle value is obtained from a steering angle of a wheel end of the mobile vehicle M, an overall steering angle of the mobile vehicle M, a steering angle of a steering wheel or a steering controller, a steering angle of a steering motor, or a stroke of a tie rod of a steering gear. However, the present disclosure is not limited thereto. Those skilled in the related art can set the first reference value based on common knowledge, operational requirements, differences in hardware configuration, and other factors of consideration. When the steering angle value is determined to be less than or equal to the first reference value, step S100 is followed by step S101, and the mobile vehicle M is determined to be in a straight-traveling mode. When the mobile vehicle M is in the straight-traveling mode, there is no need to set drive torques of a left rear wheel and a right rear wheel to be different from each other, and the vehicle enters a longitudinal control mode.

When the steering angle value is determined to be greater than the first reference value, the mobile vehicle M is then determined to be in a steering mode. At this time, step S100 is followed by step S102, which is to calculate the target yaw rate of the mobile vehicle M. That is, a theoretical yaw rate ω_{T} of the vehicle is calculated through a vehicle model (a common vehicle motion model can be, for example, a bicycle model, but is not limited thereto), and a second reference value is set according to a vehicle calibration result table. By multiplying the theoretical yaw rate ω_{T} and the second reference value, the target yaw rate can be obtained. Here, the target yaw rate is a function of the steering angle value, a vehicle speed of the mobile vehicle M, and at least one parameter specific to the mobile vehicle M.

The control method proceeds to step S104, in which a current vehicle yaw rate (i.e., an actual yaw rate ω_{S}) of the mobile vehicle M is obtained by a sensor (e.g., a vehicle sensor M2) of the mobile vehicle M, and the actual yaw rate ω_{S} is subtracted from the target yaw rate, so as to obtain a yaw error ωₑ (i.e., a yaw rate deviation).

The above-mentioned theoretical yaw rate ω_{T} can be calculated according to Formula 1 below.

$${ω}_{T} = δ \times \frac{\frac{{V}_{χ}}{L}}{1 + \frac{{KV}_{{χ}^{2}}}{57.3 Lg}} \qquad ( Formula 1 )$$

In Formula 1, δ is a steering angle, V_{X} is a vehicle speed, L is a wheelbase, and K is an understeer gradient. Here, K can be determined by taking a vehicle calibration value or a formula between steering properties of front and rear wheels and the wheelbase into consideration.

The above-mentioned second reference value (N) can be obtained from Formula 2 below and a vehicle calibration table (e.g., Vehicle Calibration Table 1 shown in FIG. 2).

N=Vehicle Calibration Table 1 (δ, L_{f}, Lᵣ, V_{X}, C_{f}, Cᵣ) (Formula 2)

In Formula 2, δ is a steering angle, L_{f} is a distance between the center of gravity and a front axle, Lᵣ is a distance between the center of gravity and a rear axle, V_{X} is a vehicle speed, C_{f} is a front-wheel cornering stiffness, and Cᵣ is rear-wheel cornering stiffness.

The above-mentioned yaw error co can be calculated according to Formula 3 below.

$${ω}_{e} = {ω}_{T} \times N - {ω}_{S} \qquad ( Formula 3 )$$

In Formula 3, N is the second reference value, and ω_{S} is the current vehicle yaw rate measured by the vehicle sensor M2.

After obtaining the yaw error, the control method proceeds to step S106, which is to determine whether or not an absolute value of the yaw error is greater than the third reference value. Here, the third reference value can be set by those skilled in the art based on factors such as operational requirements and differences in hardware configuration. When the yaw error is determined to be greater than the third reference value, at least one of a torque output by a first drive unit M3 and a torque output by a second drive unit M4 can be controlled to reduce or eliminate the yaw error.

It should be noted that the first drive unit M3 and the second drive unit M4 can each be the drive system of the mobile vehicle M, and can drive, for example, the left rear wheel and the right rear wheel of the mobile vehicle M, respectively. The target yaw rate is configured to maximize an overlapping degree between trajectories of the left rear wheel and the right rear wheel and trajectories of a left front wheel and a right front wheel of the mobile vehicle M, such that an inner wheel difference of the mobile vehicle M during turning of the mobile vehicle M is decreased or eliminated. In other words, since the inner wheel difference mainly results from trajectory differences between rear axle wheels and front axle wheels, it can be eliminated or reduced as much as possible if trajectories of the rear axle wheels can be controlled to be consistent or most consistent with those of the front axle wheels.

In the present disclosure, the control method of the drive system further includes the following processes in the process (C): calculating a first torque correction value M_{Z_FB} based on the yaw error; calculating a second torque correction value T_{FF} based on the steering angle value and the vehicle speed of the mobile vehicle M; adjusting, based on a sum of the first torque correction value M_{Z_FB} and the second torque correction value T_{FF} that are each weighted by a weighting coefficient of the first drive unit M3, the torque output by the first drive unit M3; and/or adjusting, based on a sum of the first torque correction value M_{Z_FB} and the second torque correction value T_{FF} that are each weighted by a weighting coefficient of the second drive unit M4, the torque output by the second drive unit M4.

Reference is made to FIG. 1A, FIG. 1B, FIG. 3, and FIG. 4. For example, when the yaw error is determined to be greater than the third reference value, step S106 is followed by step S108, which is to perform a feedback control action based on the yaw error. That is, the first torque correction value M_{Z_FB} that is required for eliminating the yaw error is calculated and converted into a yaw correction drive torque. The first torque correction value M_{Z_FB} can be calculated according to Formula 4 below.

$${M}_{Z \_ FB} = {K}_{P} \times {ω}_{e} + {K}_{I} \times \int {ω}_{e} dt + {K}_{D} \times \frac{{d}_{{ω}_{e}}}{dt} \qquad ( Formula 4 )$$

In Formula 4, κ_{P} is a proportional gain coefficient, κ_{I} is an integral gain coefficient, and κ_{D} is a derivative gain coefficient.

Then, the control method proceeds to step S110, which is to obtain the second torque correction value T_{FF} based on the steering angle value obtained from the steering angle sensor M1 of the mobile vehicle M and the vehicle speed obtained from a vehicle speed sensor M5 of the mobile vehicle M. By referring to Formula 5 below and the vehicle calibration table (e.g., a feedforward torque shown in Vehicle Calibration Table 2 of FIG. 3), the second torque correction value T_{FF} can be obtained. Here, the feedforward torque is a function of the vehicle speed and the steering angle, and the second torque correction value T_{FF} can be a preload yaw correction drive torque.

T_{FF}=Vehicle Calibration Table 2 (δ, V_{X}) (Formula 5)

In Formula 5, δ is a steering angle, and V_{X} is a vehicle speed.

Based on the sum of the first torque correction value M_{Z_FB} and the second torque correction value T_{FF} that are each weighted by the weighting coefficient of the first drive unit M3 (i.e., a drive torque T_{RL} of the first drive unit M3 after correction), the torque output by the first drive unit M3 can be adjusted. The first drive unit M3 can be a drive motor of the left rear wheel, but is not limited thereto. In practice, the first drive unit M3 can also be a drive motor of a front wheel or a right wheel. Formula 6 below can be used to calculate the drive torque T_{RL} of the first drive unit M3 after correction.

$${T}_{RL} = {T}_{1} + {M}_{Z \_ FB} \times {K}_{q \_ RL} + {T}_{FF} \times {K}_{FF \_ RL} \qquad ( Formula 6 )$$

Here, T₁ is a left-rear-wheel drive torque before correction, κ_{q_RL} is a conversion coefficient of the left-rear-wheel drive torque, and κ_{FF_RL} is a correction coefficient of a yaw correction drive torque of the left rear wheel.

Based on the sum of the first torque correction value M_{Z_FB} and the second torque correction value T_{FF} that are each weighted by the weighting coefficient of the second drive unit M4 (i.e., a drive torque T_{RR} of the second drive unit M4 after correction), the torque output by the second drive unit M4 can be adjusted. The second drive unit M4 can be a drive motor of the right rear wheel, but is not limited thereto. In practice, the first drive unit M3 can also be a drive motor of a front wheel or a left wheel. Formula 7 below can be used to calculate the drive torque T_{RR} of the second drive unit M4 after correction.

$${T}_{RR} = {T}_{2} + {M}_{Z \_ FB} \times {K}_{q \_ RR} + {T}_{FF} \times {K}_{FF \_ RR} \qquad ( Formula 7 )$$

Here, T₂ is a right-rear-wheel drive torque before correction, κ_{q_RR} is a conversion coefficient of the right-rear-wheel drive torque, and κ_{FF_RR} is a correction coefficient of a yaw correction drive torque of the right rear wheel.

Then, the torque output by the first drive unit M3 is adjusted based on the drive torque T_{RL} of the first drive unit M3 after correction, and/or the torque output by the second drive unit M4 is adjusted based on the drive torque T_{RR} of the second drive unit M4 after correction.

In the present disclosure, the control method of the drive system further includes the following processes in the process (C): obtaining a first wheel slip value κ_{RL} and a second wheel slip value κ_{RR} of the mobile vehicle M; calculating, in response to the first wheel slip value κ_{RL} being greater than a fourth reference value, a third torque correction value T_{κ_Modify} (κ_{RL}) based on the first wheel slip value κ_{RL}, and further using the third torque correction value T_{κ_Modify} (κ_{RL}) as a basis for adjusting the torque output by the first drive unit M3; and/or calculating, in response to the second wheel slip value κ_{RR} being greater than the fourth reference value, a fourth torque correction value T_{κ_Modify} (κ_{RR}) based on the second wheel slip value κ_{RR}, and further using the fourth torque correction value T_{κ_Modify} (κ_{RR}) as a basis for adjusting the torque output by the second drive unit M4.

The torque output by the first drive unit M3 is, in response to the first wheel slip value κ_{RL} being less than or equal to the fourth reference value, adjusted based on the sum of the first torque correction value M_{Z_FB} and the second torque correction value T_{FF} that are each weighted by the weighting coefficient of the first drive unit M3 (i.e., the drive torque T_{RL} of the first drive unit M3 after correction), and/or the torque output by the second drive unit M4 is, in response to the second wheel slip value κ_{RR} being less than or equal to the fourth reference value, adjusted based on the sum of the first torque correction value M_{Z_FB} and the second torque correction value T_{FF} that are each weighted by the weighting coefficient of the second drive unit M4 (i.e., the drive torque T_{RR} of the second drive unit M4 after correction).

Reference is made to FIG. 1A, FIG. 1B to FIG. 4. For example, before outputting corrected drive torques of left and right wheels of the rear axle, the property of a longitudinal force in the presence of a wheel slip is also taken into consideration. Since the longitudinal force of a wheel is reduced when the slip is great, a slip controller can be implemented to limit the wheel slip, thereby ensuring the stability of vehicle performance. In the slip controller, wheel speeds of the left and right wheels of the rear axle and the vehicle speed will be used for calculating the wheel slip. Hence, after step S110, the first wheel slip value κ_{RL} and the second wheel slip value κ_{RR} of the mobile vehicle M are obtained, and whether or not at least one of the first wheel slip value κ_{RL} and the second wheel slip value κ_{RR} is greater than the fourth reference value is determined (step S112). When slips of the left and right wheels of the rear axle are greater than the fourth reference value, the first wheel slip value κ_{RL} (that corresponds to the left wheel of the rear axle) is greater than the fourth reference value, and/or the second wheel slip value κ_{RR} (that corresponds to the right wheel of the rear axle) is greater than the fourth reference value. At this time, step S112 is followed by step S114. If the slips are determined to be great, adjustments need to be made to a drive force of at least one of the left and right wheels of the rear axle, and output torques of the left and right wheels of the rear axle are controlled on the premise of preventing the wheels from losing road grip. Here, the fourth reference value can be set by those skilled in the art based on common knowledge and factors such as operational requirements.

Under this circumstance, a wheel speed of each wheel (e.g., the wheel speed of the left rear wheel and that of the right rear wheel) can be detected by a wheel speed sensor M6 of the mobile vehicle M. Then, the detected wheel speeds are used to calculate slips of the left rear wheel and the right rear wheel. A left-rear-wheel slip (i.e., the first wheel slip value κ_{RL}) and a right-rear-wheel slip (i.e., the second wheel slip value κ_{RR}) can be calculated according to Formula 8 and Formula 9 below.

$${κ}_{RL} = \frac{{V}_{χ\_ RL} - {V}_{χ}}{{V}_{χ\_ RL}} \qquad ( Formula 8 )$$

$${κ}_{RR} = \frac{{V}_{χ\_ RR} - {V}_{χ}}{{V}_{χ\_ RR}} \qquad ( Formula 9 )$$

In Formula 8 and Formula 9, V_{x_RL} is a wheel center speed of the left rear wheel, V_{x_RR} is a wheel center speed of the right rear wheel, and Vₓ is a vehicle speed.

That is to say, when the slips are great, adjustments can be made to magnitude and proportion of the drive forces of the left rear wheel and the right rear wheel, so as to avoid losing road grip and maintain the ability to achieve the target yaw rate. As such, through the slip controller, a correction torque (e.g., T_{κ_Modify} (κ_{RL}) and T_{κ_Modify} (κ_{RR})) required for each of a corrected drive torque of the left wheel of the rear axle (i.e., the drive torque T_{RL} of the first drive unit M3 after correction) and a corrected drive torque of the right wheel of the rear axle (i.e., the drive torque T_{RR} of the second drive unit M4 after correction) can be calculated. The correction torque plus the corrected drive torque of the left wheel of the rear axle is equal to a left-rear-wheel drive torque T_{RL_Final} that is finally output, and the correction torque plus the corrected drive torque of the right wheel of the rear axle is equal to a right-rear-wheel drive torque T_{RR_Final} that is finally output. The left-rear-wheel drive torque T_{RL_Final} and the right-rear-wheel drive torque T_{RR_Final} that are finally output can be calculated according to Formula 10 and Formula 11 below.

$${T}_{R L \_ Final} = {T}_{RL} + {T}_{κ\_ Modify} ( {κ}_{RL} ) \qquad ( Formula 10 )$$

$${T}_{RR \_ Final} = {T}_{RR} + {T}_{κ\_ Modify} ( {κ}_{Rr} ) \qquad ( Formula 11 )$$

Conversely, when the first wheel slip value κ_{RL} is less than or equal to the fourth reference value, step S112 is followed by step S116, in which the torque output by the first drive unit M3 is adjusted based on the sum of the first torque correction value M_{Z_FB} and the second torque correction value T_{FF} that are each weighted by the weighting coefficient of the first drive unit M3 (i.e., the drive torque T_{RL} of the first drive unit M3 after correction). When the second wheel slip value κ_{RR} is less than or equal to the fourth reference value, step S112 is followed by step S116, in which the torque output by the second drive unit M4 is adjusted based on the sum of the first torque correction value M_{Z_FB} and the second torque correction value T_{FF} that are each weighted by the weighting coefficient of the second drive unit M4 (i.e., the drive torque T_{RR} of the second drive unit M4 after correction).

Through the above-mentioned configurations, the control method of the drive system provided by the present disclosure enables a vehicle that is only equipped with a front-wheel steering system to have specific functions of a four-wheel steering vehicle by controlling and outputting different torque forces (i.e., torque vectoring) to independent dual electric motors (i.e., the first drive unit M3 and the second drive unit M4) at the rear axle of the vehicle. In this way, the inner wheel difference occurred during turning can be eliminated. At the same time, the problem of a rear-axle steering system occupying space of a rear wheelhouse can be prevented, so that the vehicle can retain its originally-intended rear seat space and cargo space.

In the control method of the drive system provided by the present disclosure, when the vehicle is making a turn, the effect of eliminating trajectory differences between the rear wheels and the front wheels (i.e., trajectories of inner side wheels at the front and rear are consistent with one another) can be achieved by outputting separate torque forces required for the two rear axle wheels (which are calculated based on turning angles of the front wheels), and the inner wheel difference caused by a steering geometry can be eliminated. In this way, the vehicle that is making a turn will not come in collision with pedestrians or other road objects at a rear side of the vehicle by accident, thereby ensuring the safety of the vehicle and the pedestrians.

When the yaw error is less than the third reference value, the control method further includes the following processes: obtaining the first wheel slip value κ_{RL} and the second wheel slip value κ_{RR} of the mobile vehicle M; calculating, in response to the first wheel slip value κ_{RL} being greater than the fourth reference value, the third torque correction value T_{κ_Modify} (κ_{RL}) based on the first wheel slip value κ_{RL}, and adjusting the torque output by the first drive unit M3 based on the third torque correction value T_{κ_Modify} (κ_{RL}), such that the first wheel slip value κ_{RL} is decreased or eliminated; and/or calculating, in response to the second wheel slip value κ_{RR} being greater than the fourth reference value, the fourth torque correction value T_{κ_Modify} (κ_{RR}) based on the second wheel slip value κ_{RR}, and adjusting the torque output by the second drive unit M4 based on the fourth torque correction value T_{κ_Modify} (κ_{RR}), such that the second wheel slip value κ_{RR} is decreased or eliminated.

The torque output by the first drive unit M3 is not adjusted when the first wheel slip value κ_{RL} is less than or equal to the fourth reference value, and/or the torque output by the second drive unit M4 is not adjusted when the second wheel slip value κ_{RR} is less than or equal to the fourth reference value.

Reference is made to FIG. 2 to FIG. 5. For example, the absolute value of the yaw error being less than or equal to the third reference value indicates that a difference between the current vehicle yaw rate and a yaw rate that is capable of eliminating the inner wheel difference is small. As such, the control system does not need to adjust distribution of drive torques of the left and right wheels of the rear axle, but only needs to check the wheel slips calculated from the wheel speeds of the left and right wheels of the rear axle and the vehicle speed of the mobile vehicle M. Therefore, when the absolute value of the yaw error is less than or equal to the third reference value, step S106 is followed by step S118, which is to obtain the first wheel slip value κ_{RL} and the second wheel slip value κ_{RR}. In this step, the first wheel slip value κ_{RL} and the second wheel slip value κ_{RR} are obtained in the same manner as in step S112, and will not be reiterated herein.

The control method further proceeds to step S120, which is to determine whether or not the first wheel slip value κ_{RL} and the second wheel slip value κ_{RR} are greater than the fourth reference value. When the slips are greater than the fourth reference value, step S120 is followed by step S122. If the slips are determined to be great, the slip controller is used to adjust the drive forces of the left and right wheels of the rear axle, so as to prevent the wheels from losing road grip. Hence, the wheel speed of each wheel (e.g., the wheel speed of the left rear wheel and that of the right rear wheel) can be detected by the wheel speed sensor M6 of the mobile vehicle M. Then, the detected wheel speeds are used to calculate the slips of the left rear wheel and the right rear wheel. The left-rear-wheel slip (i.e., the first wheel slip value κ_{RL}) and the right-rear-wheel slip (i.e., the second wheel slip value κ_{RR}) are calculated according to Formula 8 and Formula 9 mentioned above.

Through the slip controller, the correction torque (i.e., the third torque correction value T_{κ_Modify} (κ_{RL}) and the fourth torque correction value T_{κ_Modify} (κ_{RR})) required for each of the left-rear-wheel drive torque T₁ before correction and the right-rear-wheel drive torque T₂ before correction is calculated, so as to obtain the left-rear-wheel drive torque T_{RL_Final} that is finally output and the right-rear-wheel drive torque T_{RR_Final} that is finally output. The left-rear-wheel drive torque T_{RL_Final} and the right-rear-wheel drive torque T_{RR_Final} that are finally output can be calculated according to Formula 12 and Formula 13 below.

$${T}_{R L \_ Final} = {T}_{1} + {T}_{κ\_ Modify} ( {κ}_{RL} ) \qquad ( Formula 12 )$$

$${T}_{RR \_ Final} = {T}_{2} + {T}_{κ\_ Modify} ( {κ}_{RR} ) \qquad ( Formula 13 )$$

When the slips are less than or equal to the fourth reference value, step S120 is followed by step S124. In step S124, at least one of the torque output by the first drive unit M3 and the torque output by the second drive unit M4 is not adjusted.

Based on the descriptions above (as shown in FIG. 1A, FIG. 1B to FIG. 5), the present disclosure further provides a control system Z of the mobile vehicle M. The control system Z includes at least one control unit Z1, and the control system Z performs the above-mentioned control method of the drive system by the at least one control unit Z1. The control unit Z1 can be an electronic control apparatus or a computation chip, but is not limited thereto.

Referring to FIG. 6, the control system Z of the present disclosure can further include a computation control unit Z2 and a motor control unit (MCU) Z3. The computation control unit Z2 is in signal communication with the motor control unit Z3 through a controller area network (CAN), so as to obtain the steering angle value of the mobile vehicle M. The computation control unit Z2 is also in signal communication with the steering angle sensor M1, the vehicle sensor M2, and the vehicle speed sensor M5 through the controller area network. Hence, the computation control unit Z2 can obtain a steering angle through the steering angle sensor M1. In addition, the computation control unit Z2 can perform the above-mentioned control method. That is, the computation control unit Z2 can determine whether or not the steering angle value is greater than the first reference value, and perform the processes (A), (B), and (C). A control signal of the controller area network is further transmitted to the motor control unit Z3. As shown in FIG. 6 and FIG. 7, the control system Z of FIG. 7 includes an electronic stability control unit Z4 as compared with the control system Z of FIG. 6. A computation control software is stored in the electronic stability control unit Z4. The electronic stability control unit Z4 includes the above-mentioned slip controller, and is in signal communication with the steering angle sensor M1, the vehicle sensor M2, the vehicle speed sensor M5, the wheel speed sensor M6, and the motor control unit Z3 through the controller area network. Since the electronic stability control unit Z4 includes the slip controller, and is in signal communication with the wheel speed sensor M6, the control system Z of FIG. 7 can further determine whether or not the slip is excessive at the wheel end through the electronic stability control unit Z4 (as compared with the control system Z of FIG. 6), so as to perform torque correction. Moreover, as shown in FIG. 7 and FIG. 8, the control system Z of FIG. 8 is different from the control system Z of FIG. 7 in that a domain control unit (DCU) Z5 of the control system Z of FIG. 8 replaces the electronic stability control unit Z4 and the motor control unit Z3 of the control system Z of FIG. 7. The computation control software is recorded in the domain control unit Z5. The domain control unit Z5 can obtain the steering angle value of the mobile vehicle M through a communication network, and perform the above-mentioned control method. That is, the domain control unit Z5 can also determine whether or not the steering angle value is greater than the first reference value, and perform the processes (A), (B), and (C).

The aforementioned examples describe only one of the embodiments of the present disclosure, and the present disclosure is not intended to be limited thereto.

### Beneficial Effects of the Embodiments

In conclusion, in the control method of the drive system provided by the present disclosure, by virtue of “(A) calculating the target yaw rate of the mobile vehicle M,” “(B) calculating the difference between the actual yaw rate of the mobile vehicle M and the target yaw rate to obtain the yaw error,” and “(C) controlling, in response to the yaw error being greater than the third reference value, at least one of the torque output by the first drive unit M3 and the torque output by the second drive unit M4, such that the yaw error is decreased or eliminated,” the occurrence of the inner wheel difference during turning of the mobile vehicle M can be eliminated.

Furthermore, in the control system of the mobile vehicle provided by the present disclosure, by virtue of “the control system Z including a first control unit and a second control unit,” “the first control unit being communicatively connected to the second control unit, and the control system performing the control method,” and “the control method including: (A) calculating, by the first control unit, the target yaw rate of the mobile vehicle M; (B) calculating, by the first control unit, the difference between the actual yaw rate of the mobile vehicle M and the target yaw rate to obtain the yaw error; and (C) controlling, by the second control unit, at least one of the torque output by the first drive unit M3 of the mobile vehicle M and the torque output by the second drive unit M4 of the mobile vehicle M in response to the first control unit determining that the yaw error is greater than the third reference value, such that the yaw error is decreased or eliminated,” the occurrence of the inner wheel difference during turning of the mobile vehicle M can be eliminated.

Furthermore, in the domain control unit of the mobile vehicle provided by the present disclosure, by virtue of “the domain control unit Z5 performing the control method” and “the control method including: (A) calculating the target yaw rate of the mobile vehicle M; (B) calculating the difference between the actual yaw rate of the mobile vehicle M and the target yaw rate to obtain the yaw error; and (C) controlling, in response to determining that the yaw error is greater than the third reference value, at least one of the torque output by the first drive unit M3 of the mobile vehicle M and the torque output by the second drive unit M4 of the mobile vehicle M, such that the yaw error is decreased or eliminated,” the occurrence of the inner wheel difference during turning of the mobile vehicle M can be eliminated.

More specifically, in the control method of the drive system for the mobile vehicle M, the control system Z, and the domain control unit Z5 provided by the present disclosure, from the perspective of integrated dynamic control of the vehicle, different torque forces (i.e., torque vectoring) are controlled to be output to the independent dual electric motors (i.e., the first drive unit M3 and the second drive unit M4) at the rear axle. In this way, when the vehicle is making a turn, the effect of eliminating trajectory differences between the rear wheels and the front wheels (i.e., trajectories of inner side wheels at the front and rear are consistent with one another) can be achieved by outputting separate torque forces required for the two rear axle wheels (which are calculated based on turning angles of the front wheels), and the inner wheel difference caused by the steering geometry can be eliminated.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A control method of a drive system, which is applied to a mobile vehicle, the control method comprising:
(A) calculating a target yaw rate of the mobile vehicle;
(B) calculating a difference between an actual yaw rate of the mobile vehicle and the target yaw rate to obtain a yaw error; and
(C) controlling, in response to the yaw error being greater than a third reference value, at least one of a torque output by a first drive unit and a torque output by a second drive unit, such that the yaw error is decreased or eliminated.

2. The control method according to claim 1, further comprising:
obtaining a steering angle value of the mobile vehicle, and performing the processes (A), (B), and (C) when the steering angle value is greater than a first reference value.

3. The control method according to claim 2, wherein the process (C) includes:
calculating a first torque correction value based on the yaw error;
calculating a second torque correction value based on the steering angle value and a vehicle speed of the mobile vehicle;
adjusting, based on a sum of the first torque correction value and the second torque correction value that are each weighted by a weighting coefficient of the first drive unit, the torque output by the first drive unit; and/or
adjusting, based on a sum of the first torque correction value and the second torque correction value that are each weighted by a weighting coefficient of the second drive unit, the torque output by the second drive unit.

4. The control method according to claim 3, wherein the process (C) further includes:
obtaining a first wheel slip value and a second wheel slip value of the mobile vehicle;
calculating, in response to the first wheel slip value being greater than a fourth reference value, a third torque correction value based on the first wheel slip value, and further using the third torque correction value as a basis for adjusting the torque output by the first drive unit; and/or
calculating, in response to the second wheel slip value being greater than the fourth reference value, a fourth torque correction value based on the second wheel slip value, and further using the fourth torque correction value as a basis for adjusting the torque output by the second drive unit.

5. The control method according to claim 2, wherein the target yaw rate is a function of the steering angle value, a vehicle speed of the mobile vehicle, and at least one parameter specific to the mobile vehicle.

6. The control method according to claim 1, wherein, when the yaw error is less than the third reference value, the control method further comprises:
obtaining a first wheel slip value and a second wheel slip value of the mobile vehicle;
calculating, in response to the first wheel slip value being greater than a fourth reference value, a third torque correction value based on the first wheel slip value, and adjusting the torque output by the first drive unit based on the third torque correction value, such that the first wheel slip value is decreased or eliminated; and/or
calculating, in response to the second wheel slip value being greater than the fourth reference value, a fourth torque correction value based on the second wheel slip value, and adjusting the torque output by the second drive unit based on the fourth torque correction value, such that the second wheel slip value is decreased or eliminated.

7. The control method according to claim 1, wherein the first drive unit and the second drive unit drive a left rear wheel and a right rear wheel of the mobile vehicle, respectively; wherein the target yaw rate is configured to maximize an overlapping degree between trajectories of the left rear wheel and the right rear wheel and trajectories of a left front wheel and a right front wheel of the mobile vehicle, such that an inner wheel difference of the mobile vehicle during turning of the mobile vehicle is decreased or eliminated.

8. The control method according to claim 2, wherein the steering angle value is obtained from a steering angle of a wheel end of the mobile vehicle, an overall steering angle of the mobile vehicle, a steering angle of a steering wheel or a steering controller, a steering angle of a steering motor, or a stroke of a tie rod of a steering gear.

9. A control system of a mobile vehicle, comprising:
a first control unit; and
a second control unit;
wherein the first control unit is communicatively connected to the second control unit, the control system performs a control method, and the control method includes:
(A) calculating, by the first control unit, a target yaw rate of the mobile vehicle;
(B) calculating, by the first control unit, a difference between an actual yaw rate of the mobile vehicle and the target yaw rate to obtain a yaw error; and
(C) controlling, by the second control unit, at least one of a torque output by a first drive unit of the mobile vehicle and a torque output by a second drive unit of the mobile vehicle in response to the first control unit determining that the yaw error is greater than a third reference value, such that the yaw error is decreased or eliminated.

10. The control system according to claim 9, wherein the first control unit is communicatively connected to a steering angle sensor of the mobile vehicle; wherein, when the first control unit obtains a steering angle value of the mobile vehicle by the steering angle sensor and determines that the steering angle value is greater than a first reference value, the control system performs the processes (A), (B), and (C).

11. The control system according to claim 10, wherein, when the control system performs the process (C), further processes include:
calculating, by the first control unit, a first torque correction value based on the yaw error;
calculating, by the first control unit, a second torque correction value based on the steering angle value and a vehicle speed of the mobile vehicle;
adjusting, by the second control unit, the torque output by the first drive unit based on a sum of the first torque correction value and the second torque correction value that are each weighted by a weighting coefficient of the first drive unit; and/or
adjusting, by the second control unit, the torque output by the second drive unit based on a sum of the first torque correction value and the second torque correction value that are each weighted by a weighting coefficient of the second drive unit.

12. The control system according to claim 11, wherein, when the control system performs the process (C), further processes include:
obtaining, by the first control unit, a first wheel slip value and a second wheel slip value of the mobile vehicle;
calculating, in response to the first control unit determining that the first wheel slip value is greater than a fourth reference value, a third torque correction value based on the first wheel slip value, and further using the third torque correction value as a basis for adjusting the torque output by the first drive unit; and/or
calculating, in response to the first control unit determining that the second wheel slip value is greater than the fourth reference value, a fourth torque correction value based on the second wheel slip value, and further using the fourth torque correction value as a basis for adjusting the torque output by the second drive unit.

13. The control system according to claim 10, wherein the first control unit is a computation control unit or an electronic stability control unit, and the second control unit is a motor control unit; wherein the steering angle value is obtained from a steering angle of a wheel end of the mobile vehicle, an overall steering angle of the mobile vehicle, a steering angle of a steering wheel or a steering controller, a steering angle of a steering motor, or a stroke of a tie rod of a steering gear; wherein the target yaw rate is a function of the steering angle value, a vehicle speed of the mobile vehicle, and at least one parameter specific to the mobile vehicle.

14. The control system according to claim 9, wherein, when the first control unit determines that the yaw error is less than the third reference value, the control system performs processes of:
obtaining, by the first control unit, a first wheel slip value and a second wheel slip value of the mobile vehicle;
calculating, in response to the first control unit determining that the first wheel slip value is greater than a fourth reference value, a third torque correction value based on the first wheel slip value, and using the second control unit to adjust the torque output by the first drive unit based on the third torque correction value, such that the first wheel slip value is decreased or eliminated; and/or
calculating, in response to the first control unit determining that the second wheel slip value is greater than the fourth reference value, a fourth torque correction value based on the second wheel slip value, and using the second control unit to adjust the torque output by the second drive unit based on the fourth torque correction value, such that the second wheel slip value is decreased or eliminated.

15. The control system according to claim 9, wherein the first drive unit and the second drive unit drive a left rear wheel and a right rear wheel of the mobile vehicle, respectively; wherein the target yaw rate is configured to maximize an overlapping degree between trajectories of the left rear wheel and the right rear wheel and trajectories of a left front wheel and a right front wheel of the mobile vehicle, such that an inner wheel difference of the mobile vehicle during turning of the mobile vehicle is decreased or eliminated.

16. A domain control unit of a mobile vehicle, characterized in that the domain control unit performs a control method, and the control method includes:
(A) calculating a target yaw rate of the mobile vehicle;
(B) calculating a difference between an actual yaw rate of the mobile vehicle and the target yaw rate to obtain a yaw error; and
(C) controlling, in response to determining that the yaw error is greater than a third reference value, at least one of a torque output by a first drive unit of the mobile vehicle and a torque output by a second drive unit of the mobile vehicle, such that the yaw error is decreased or eliminated.

17. The domain control unit according to claim 16, wherein the domain control unit is connected to a steering angle sensor of the mobile vehicle; wherein, when the domain control unit obtains a steering angle value of the mobile vehicle by the steering angle sensor and determines that the steering angle value is greater than a first reference value, the domain control unit performs the processes (A), (B), and (C).

18. The domain control unit according to claim 17, wherein the domain control unit performing the process (C) further includes performing processes of:
calculating a first torque correction value based on the yaw error;
calculating a second torque correction value based on the steering angle value and a vehicle speed of the mobile vehicle;
adjusting, based on a sum of the first torque correction value and the second torque correction value that are each weighted by a weighting coefficient of the first drive unit, the torque output by the first drive unit;
and/or adjusting, based on a sum of the first torque correction value and the second torque correction value that are each weighted by a weighting coefficient of the second drive unit, the torque output by the second drive unit.

19. The domain control unit according to claim 18, wherein the domain control unit performing the process (C) further includes performing processes of:
obtaining a first wheel slip value and a second wheel slip value of the mobile vehicle;
calculating, in response to determining that the first wheel slip value is greater than a fourth reference value, a third torque correction value based on the first wheel slip value, and further using the third torque correction value as a basis for adjusting the torque output by the first drive unit; and/or
calculating, in response to determining that the second wheel slip value is greater than the fourth reference value, a fourth torque correction value based on the second wheel slip value, and further using the fourth torque correction value as a basis for adjusting the torque output by the second drive unit.

20. The domain control unit according to claim 16, wherein, when the domain control unit determines that the yaw error is less than the third reference value, the domain control unit performs processes of:
obtaining a first wheel slip value and a second wheel slip value of the mobile vehicle;
calculating, in response to determining that the first wheel slip value is greater than a fourth reference value, a third torque correction value based on the first wheel slip value, and adjusting the torque output by the first drive unit based on the third torque correction value, such that the first wheel slip value is decreased or eliminated; and/or
calculating, in response to determining that the second wheel slip value is greater than the fourth reference value, a fourth torque correction value based on the second wheel slip value, and adjusting the torque output by the second drive unit based on the fourth torque correction value, such that the second wheel slip value is decreased or eliminated.
